(19) United States
(12) Patent Application Publication
(10) Pub. No.: US 2008/0259962 A1
(43) Pub. Date: Oct. 23, 2008

(54) Contents reproducing apparatus

(75) Inventors: Hirofumi Mori, Koganei-shi (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/998,937

(22) Filed: Dec. 3, 2007

(30) Foreign Application Priority Data
Apr. 20, 2007 (JP) 2007-112256

(51) Int. Cl. H04J 3/00

(52) U.S. Cl. 370/498

(57) ABSTRACT

A contents reproducing apparatus includes a receiving unit configured to receive a plurality of packets that convey an elementary stream containing encoded video or audio data and time information, a detecting unit configured to detect a discontinuity of timebase if the difference between first time information contained in a first packet and second time information contained in a second packet received before the first packet is larger than a first threshold value, a timer configured to output the current time after a second threshold value smaller than the first threshold value elapses from a time to receive the first packet, and a generating unit configured to generate a third packet including a third time information calculated based on the first time information and transfer the third packet to the receiving unit, when receiving the current time from the timer.

### CROSS-REFERENCE TO RELATED APPLICATIONS

This application is based upon and claims the benefit of priority from prior Japanese Patent Application No. 2007-112256, filed Apr. 20, 2007, the entire contents of which are incorporated herein by reference.

### BACKGROUND OF THE INVENTION

1. Field of the Invention

The present invention relates to an apparatus for reproducing video or audio data transmitted by a transport stream.

2. Description of the Related Art

In digital terrestrial broadcasting received by a 3rd-generation (3G) cellular phone (e.g. one-segment in Japan), video data is encoded by H.264/AVC, and audio data is encoded by MPEG-2 AAC. These encoded video and audio data are called elementary streams (ES), and packetized as a packetized elementary stream (PES) packet respectively. And these PES packets are multiplexed and transmitted in a transport stream in MPEG-2 systems. In a transport stream, a transport stream packet (TS packet) is arranged. A TS packet can contain attribute information indicating the attribute of a bitstream composing video and audio data, a bitstream, and reference clock information called a program clock reference (PCR) for synchronizing media. A TS packet is transmitted wirelessly or through a wire.

PCR is used to adjust a system time clock (STC) for clock synchronizing with a transmitting side. More specifically, STC is adjusted by extracting a value obtained by sampling PCR of a transmitting side at 27 MHz and comparing the obtained value with the count of STC in a receiving side (clock recovery), as disclosed in “Revised Digital Broadcasting Textbook-I” Impress, October 2004, p. 85-87, supervised by Wataru Kameyama & Tsuyoshi Hanamura, for example. In a receiving side, when STC counted by a STC counter exceeds a presentation time stamp (PTS) included in a TS packet, ES is synchronously regenerated. A method of synchronizing with a transmitting side by a simple configuration by loading a received PCR into a STC counter without adjusting a clock by PCR is also known.

A timebase, which may indicate offset of STC or PCR increasing monotonically with 27 MHz, may be changed at a midpoint in a transport stream. When a discontinuity of timebase is detected, a reset including initial settings of PCR or PTS becomes necessary. As one of the methods for detecting a discontinuity of timebase, there is a method of referring to a discontinuity indicator included in an adaptation field in a TS packet, as disclosed in Jpn. Pat. Appln. KOKAI Publication No. 2000-287172. When a timebase is changed, a transmitting side transmits a TS packet by setting a discontinuity indicator to “1”, and the discontinuity of timebase can be correctly detected if the receiving environment of a receiving side is good.

There is another method of detecting a discontinuity of timebase, which detects a discontinuity of timebase by comparing a predetermined threshold value with the difference between PCR included in a received TS packet and STC when receiving that PS packet. There is still another method of detecting the discontinuity of timebase, which detects a discontinuity of timebase by calculating the difference between a newly received PCR and a previously received PCR, and comparing the difference with a predetermined threshold value, whenever receiving a TS packet including PCR.

When detecting a discontinuity of timebase by using a discontinuity indicator, a discontinuity of timebase may be overlooked. Namely, if a TS packet with the discontinuity indicator set to “1” is not received due to an error, a discontinuity of timebase cannot be detected. Therefore, a discontinuity of timebase is not exactly detected in environment with a weak electric field where an error is likely to occur.

Further, when detecting a discontinuity of timebase by using the difference between a newly received PCR and a previously received PCR, a discontinuity of timebase may be erroneously detected. Namely, an increment of PCR in a period while PCR is missing due to an error exceeds the above-mentioned threshold value, a discontinuity of timebase will be erroneously detected when PCR is received again.

When detecting a timebase discontinuity by using the difference between STC and PCR, there is a problem that the accuracy of detecting a discontinuity of timebase depends on the accuracy of synchronization between transmission and reception. Namely, as a clock error may occur between transmission and reception in the configuration in which the above-mentioned clock recovery is not performed, if PCR cannot be loaded into a STC counter in a receiving side for a long time due to an error, the clock error is accumulated, and a discontinuity of timebase will be erroneously detected.

### BRIEF SUMMARY OF THE INVENTION

According to the invention, there is provided a reproducing apparatus, which can correctly detect a discontinuity of timebase even if a TS packet is missing.

According to an aspect of the invention, there is provided a reproducing apparatus comprising: a receiving unit configured to receive a plurality of packets that convey an elementary stream containing encoded video or audio data and time information; a detecting unit configured to detect a discontinuity of timebase if the difference between first time information contained in a first packet and second time information contained in a second packet received before the first packet is larger than a first threshold value; a timer configured to output the current time after a second threshold value smaller than the first threshold value elapses from a time to receive the first packet; a generating unit configured to generate a third packet including a third time information calculated based on the first time information and transfer the third packet to the receiving unit, when receiving the current time from the timer; and a decoder configured to decode the video or audio data contained in the elementary stream.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing a stream reproducing apparatus according to an embodiment of the invention;

FIG. 2 is a diagram showing the structure of a TS packet received by the packet receiving unit shown in FIG. 1, the structure of a transport stream consisting of the TS packet, and the structure of a PES packet stored in a payload in the TS packet;

FIG. 3A is a diagram showing the structure of a TS header in the TS packet shown in FIG. 2;

FIG. 3B is a diagram showing the structure of an adaptation field in the TS packet shown in FIG. 2;

FIG. 3C is a diagram showing the structure of the PES header shown in FIG. 2;

FIG. 4 is a graph showing an example that a discontinuity detecting unit shown in FIG. 1 erroneously detects a discontinuity of timebase;

FIG. 5 is a graph showing an example that a PCR packet generating unit shown in FIG. 1 generates a packet in an error section in the graph shown in FIG. 4;

FIG. 6 is a flowchart showing the processing of a TS packet in the stream reproducing apparatus shown in FIG. 1; and

FIG. 7 is a flowchart showing the operations of the PCR packet generating unit shown in FIG. 1.

### DETAILED DESCRIPTION OF THE INVENTION

Hereinafter, an embodiment of the invention will be explained with reference to the accompanying drawings.

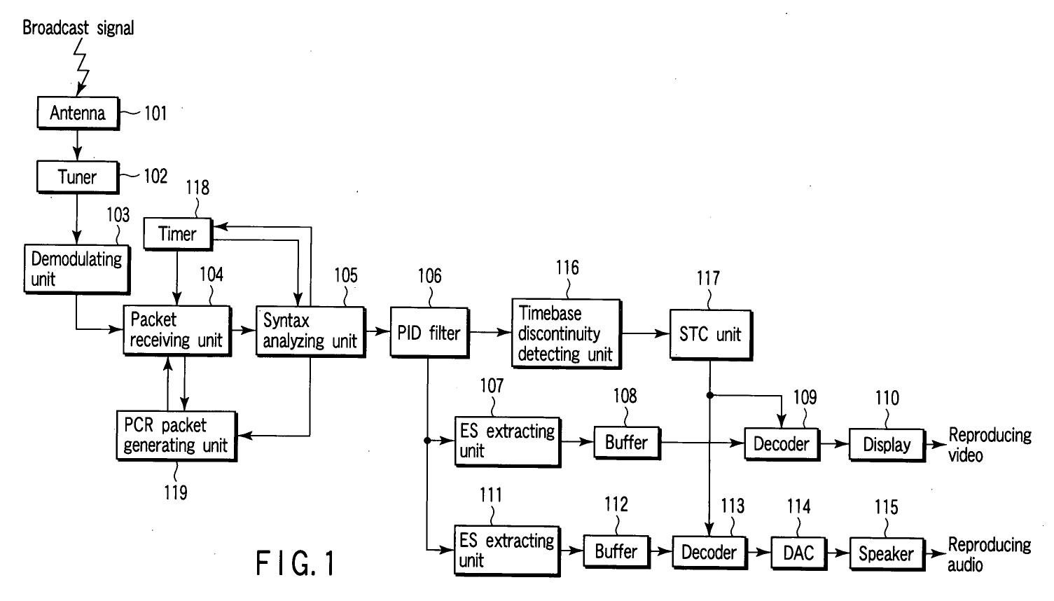

FIG. 1 shows an exemplary configuration of a reproducing apparatus according to an embodiment of the invention. The reproducing apparatus has an antenna 101, a tuner 102, a demodulating unit 103, a packet receiving unit 104, a syntax analyzing unit 105, a PID filter 106, an ES (Elementary Stream) extracting unit 107, a buffer 108, a decoder 109, a display 110, an ES extracting unit 111, a buffer 112, a decoder 113, a DAC 114, a speaker 115, a discontinuity detecting unit 116, a STC unit 117, a timer 118, and a PCR packet generating unit 119.

The antenna 101 receives a broadcast signal transmitted from a broadcasting station, and transfers the received signal to the tuner 102. The tuner 102 selects a specified channel from the broadcast signal, which contains a plurality of channels, received through the antenna 101. The demodulating unit 103 demodulates a signal transmitted in the channel selected by the tuner 102 and extracts a transport stream.

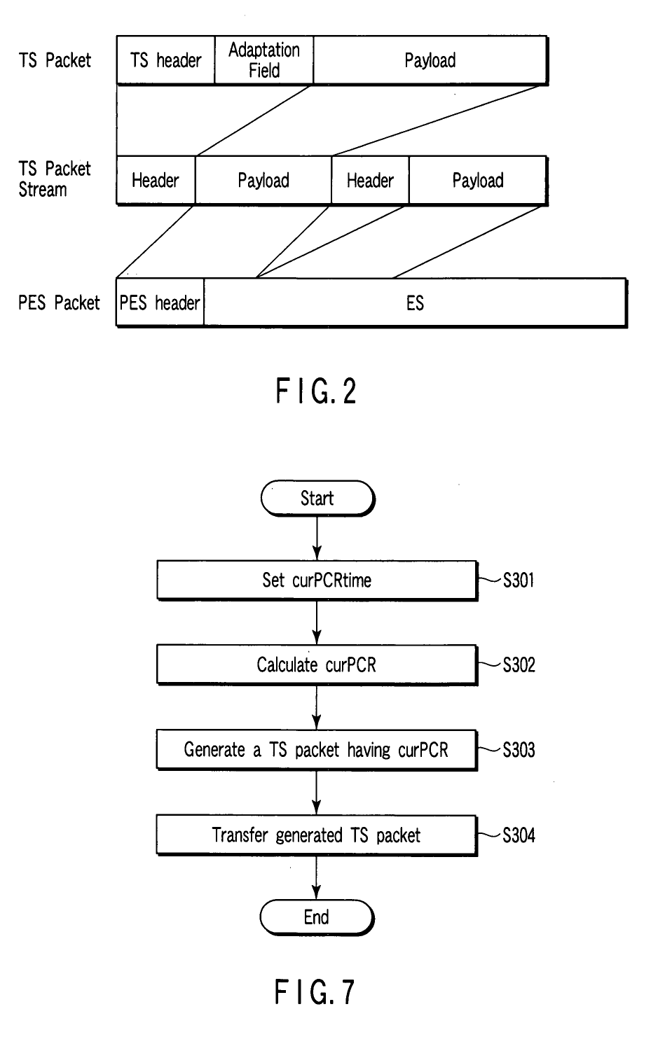

The packet receiving unit 104 receives the transport stream output from the demodulating unit 103 in units of TS packet, and transfers the TS packets to the syntax analyzing unit 105. As shown in FIG. 2, a TS packet is a 188-byte fixed length packet and contains a 4-byte TS header, an adaptation field, and a payload. The adaptation field is an optional and need not be contained in the TS packet. Also, as shown in of FIG. 2, a TS packet is arranged in a TS Packet stream. Meanwhile, the TS Packet stream could be called a transport stream. In FIG. 2, a TS header and an adaptation field in the TS Packet stream are expressed as a header for the sake of convenience.

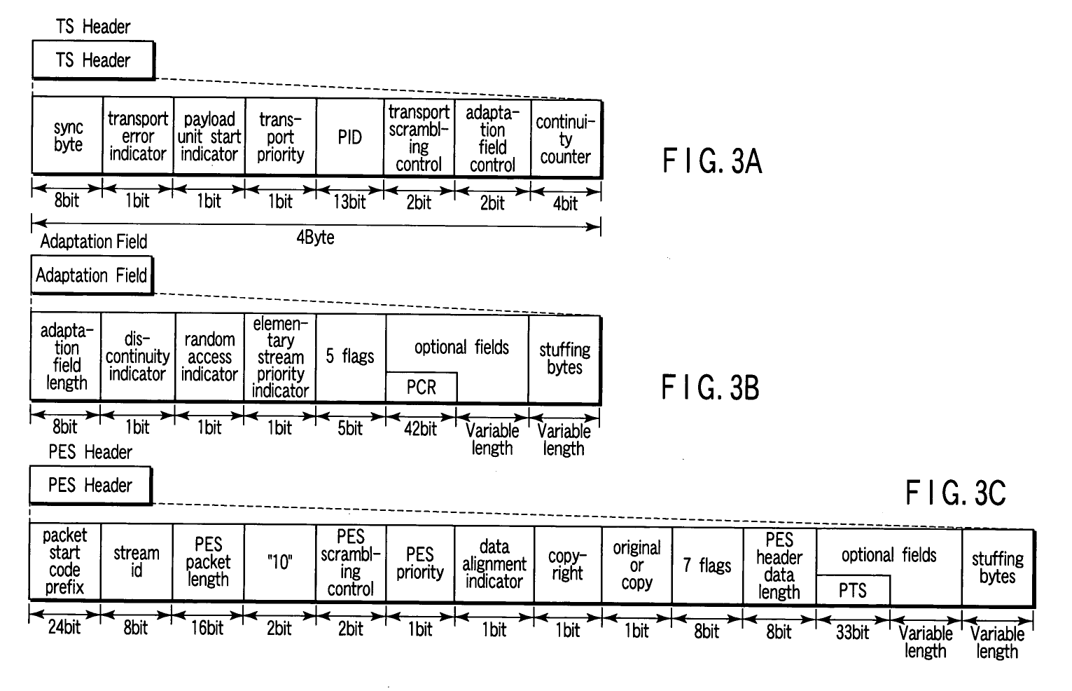

As shown in FIG. 3A, a TS header contains a 13-bit packet ID (PID), which makes it possible to determine which of the video data and audio data is transmitted by a TS packet. Namely, as the same video data and audio data have the same PID, ES before packetized can be restored by using PID.

Further, a TS header includes a 1-bit transport error indicator indicating the presence or absence of an error occurred in a TS packet, and a 2-bit adaptation field control indicating the presence or absence of an adaptation field or payload. Here, as the adaptation field control, “11” is defined as “presence of an adaptation field and payload”, “10” is defined as “presence of an adaptation field, and absence of a payload”, “01” is defined as “absence of an adaptation field, and presence of a payload”, and “00” is defined as “RFU (Reserved for Future Use)”, respectively.

The TS header also has a sync byte indicating the beginning of the TS packet. The TS header also has a payload unit start indicator indicating a new PES packet start from a payload in the TS packet. The TS header also has a transport priority indicating the importance of the TS packet, and a 2-bit transport scrambling control indicating the presence or absence of a scramble of a payload in the TS packet. The TS header also has a 4-bit continuity counter for detecting discontinuity of the TS packets having the same PID.

As shown in FIG. 3B, an adaptation field has a variable length optional field, and a 42-bit PCR is included in this optional field. Further, an adaptation field has an 8-bit adaptation field length, a 1-bit discontinuity indicator indicating the presence or absence of a discontinuity of timebase, a random access indicator, an elementary stream priority indicator, 5 flags including a 1-bit PCR flag indicating the presence or absence of PCR in an adaptation field, and variable length stuffing bytes.

As shown in FIG. 2, a payload of the TS Packet contains part of a PES packet, which is packetized by adding a header called a PES header to ES (Elementary Stream). That is to say, the PES packet is divided into a plurality of segments comparable in size to the payload of the TS Packet.

As shown in FIG. 3C, a PES header contains PTS (Presentation Time Stamp) corresponding to the first frame in a PES packet in a 33-bit field. Here, a PES header consists of a 24-bit packet start prefix, an 8-bit stream ID, a 16-bit PES packet length, “10”, a 2-bit PES scrambling control, a PES priority, a data alignment indicator, a copy right, an original or copy, 7 flags, an 8-bit PES header length, a variable length optional field to store PTS, and variable length stuffing bytes.

Receiving time from the timer 118, the packet receiving unit 104 actuates the PCR packet generating unit 119, and transfers the received time, as described later. The packet receiving unit 104 receives a packet generated by the PCR packet generating unit 119, and transfers the PCR packet to the syntax analyzing unit 105.

The syntax analyzing unit 105 analyzes each syntax in the TS header and adaptation field in the packet transferred from the packet receiving unit 104. When the syntax analyzing unit 105 detects that PCR is included in the TS packet as a result of analyzing a PCR flag in the adaptation field, the syntax analyzing unit sets the timer 118, and obtains a value indicating the current time (prevPCRtime). The syntax analyzing unit 105 transfers PCR (curPCR) to be processed, the prevPCRtime obtained from the timer 118 and the PID indicating the TS packet including PCR, to the PCR packet generating unit 119 described later.

The PID filter 106 processes the TS packet based on the PID analyzed by the syntax analyzing unit 105. More specifically, a value of PID and a corresponding type of TS packet are set in the PID filter 106, based on table information called PMT (Program Map Table) given to each program.

In PMT, a value of PID corresponds to a type of TS packet, and it is possible to determine that a TS packet having a specific value of PID is any one of video, audio, caption and PCR. PCR is contained in an adaptation field in a TS packet, as described above, and may be transmitted together with a payload including video and audio, or may be transmitted alone without accompanied by a payload. Therefore, a specific value of PID may indicate a TS packet including PCR only, or may indicate a TS packet including both PCR and video. If a user changes a TV program to be watched, the PID filter 106 is reset based on PMT.

When an input TS packet indicates video data, the PID filter 106 transfers the TS packet to the ES extracting unit 107. When an input TS packet indicates audio data, the PID filter 106 transfers the TS packet to the ES extracting unit 111. When an input TS packet includes PCR, the PID filter 106 transfers the PCR to the discontinuity detecting unit 116. When the input TS packet is caption, etc., the PID filter 106 transfers the TS packet to a processing unit (not shown). When PID of the input TS packet is not set, the PID filter 106 abandons the TS packet.

The ES extracting unit 107 extracts ES for video from a TS packet having that ES provided from the PID filter 106, and buffers the ES in the buffer 108. The decoder 109 acquires the ES stored in the buffer 108, decodes the ES, and obtains video data. When a value of STC from the STC unit 117 becomes larger than PTS of ES, the decoded video data is reproduced by the display 110.

The ES extracting unit 111 extracts ES for audio from a TS packet having that ES provided from the PID filter 106, and buffers the ES in the buffer 112. The decoder 113 acquires the ES stored in the buffer 112, decodes it, and obtains audio data. When a value of STC from the STC unit 117 becomes larger than PTS of ES, the decoded audio data is converted from digital to analog by a digital-analog converter (DAC) 114, and reproduced through a speaker 115.

When PCR (curPCR) is provided from the PID filter 106, the discontinuity detecting unit 116 calculates the difference ΔPCR between the provided PCR and the previously provided PCR (curPCR), and compares the difference with a predetermined threshold value THtbd. When the difference ΔPCR is larger than the threshold value THtbd, the discontinuity detecting unit 116 detects a discontinuity of timebase. Further, the discontinuity detecting unit 116 stores curPCR as a new prevPCR for processing the next PCR provided from the PID filter 106.

Now, the threshold value THtbd will be explained. Usually, a maximum cycle to transmit a TS packet including PCR from a transmitting side such as a contents server is defined, and a transmitting side transmits a TS packet including PCR at intervals lower than this maximum cycle. For example, in digital terrestrial broadcasting (referred to as one-segment) for cellular phones in Japan, it is defined that a TS packet including PCR is transmitted at a maximum cycle of 257.04 m sec from a transmitting side. Namely, if a receiving side such as a cellular phone or a portable PC can normally receive a TS packet including PCR, the difference ΔPCR between continued PCRs must be lower than the above-mentioned maximum cycle, and if the difference ΔPCR is larger than the maximum cycle, it can be determined that a discontinuity of timebase has occurred. Therefore, a discontinuity of timebase can be detected by comparing with ΔPCR by using the maximum cycle as the threshold value THtbd, for example.

When prevPCR does not exist, or when curPCR is PCR provided first by the PID filter 106, the discontinuity detecting unit 116 stores the curPCR as prevPCR without detecting a discontinuity of timebase. The discontinuity detecting unit 116 has a flag (referred to as “firstPCR indicating whether PCR provided from the PID filter 106 is the firstPCR flag or not. The firstPCR flag is set to true at the start of reproducing a stream, and set to false when the discontinuity detecting unit 116 receives the firstPCR flag. Therefore, when PCR is transferred, the discontinuity detecting unit 116 first refers to the firstPCR flag, and determines the processing for that PCR.

The STC unit 117 transmits a value of STC counting STC of a certain frequency as time to the decoders 109 and 113. The STC unit 117 prevents stacking of a clock error with respect to a transmitting side by loading PCR transferred from the discontinuity detecting unit 116, and updating a value of STC.

When the syntax analyzing unit 105 sets the timer 118, the timer 118 returns prevPCRtime indicating the current time upon the setting to the syntax analyzing unit 105. When a predetermined threshold value THtime elapses from the prevPCRtime, the timer 118 transmits the current time (curPCRtime) to the packet receiving unit 104. Here, the threshold value THtime is shorter than the above-mentioned THtbd. If the timer 118 is reset by the syntax analyzing unit 105 before the threshold value THtime elapses, the timer updates prevPCRtime by the current time upon the resetting, and waits again until the threshold value THtime elapses.

The PCR packet generating unit 119, when activated by the packet receiving unit 104, generates a TS packet by calculating a pseudo PCR, and transfers the TS packet to the packet receiving unit 104. Namely, the PCR packet generating unit 119 generates a TS packet having a pseudo PCR calculated based on the curPCRtime obtained from the packet receiving unit 104, and prevPCR and prevPCRtime obtained from the syntax analyzing unit 105. More specifically, the PCR packet generating unit 119 calculates a pseudo PCR by adding the difference between curPCRtime and prevPCRtime to prevPCR. The PCR packet generating unit 119 generates a TS packet by adding PID indicating the TS packet including PCR to the obtained PCR, and transfers the TS packet to the packet receiving unit 104. The PCR packet generating unit 119 generates a TS packet by using stuffing bytes in the parts other than PID and PCR by, for example. A TS packet generated by the PCR packet generating unit 119 is received by the packet receiving unit 104, like an ordinary TS packet received from a broadcast signal, analyzed by the syntax analyzing unit 105, and provided to the discontinuity detecting unit 116 as PCR by the PID filter 106.

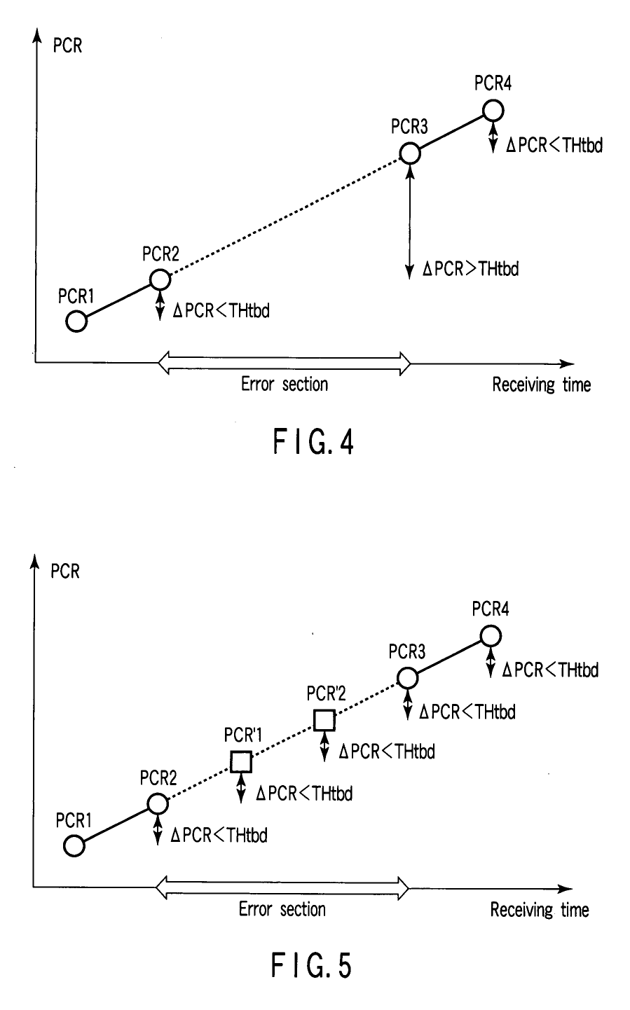

Hereinafter, explanation will be given of the technical significance that the PCR packet generating unit 119 generates a TS packet. Assume that a TS packet including PCR3 and PCR4 is received through a receiving error section, after receiving a TS packet including PCR1 and PCR2, as shown in FIG. 4. Here, it is assumed that the timebase of PCR1 to PCR4 is the same, and the receiving error section is longer than the threshold value THtbd. As described above, the discontinuity detecting unit 116 detects a discontinuity of the timebase of PCR1 to PCR4. First, as PCR1 is the first PCR, the discontinuity detecting unit 116 does not detect a discontinuity of timebase, and records the PCR1 as prevPCR, as described above. Then, the discontinuity detecting unit 116 calculates ΔPCR by regarding the PCR2 as curPCR. As ΔPCR (=PCR2−PCR1) is lower than the threshold value THtbd, a discontinuity of timebase is not detected, and the discontinuity detecting unit 116 records the PCR2 as prevPCR. Then, through the receiving error section, the discontinuity detecting unit 116 calculates ΔPCR by regarding the PCR3 as curPCR. As PCR that should be received between PCR2 and PCR3 has not been received, ΔPCR (=PCR3−PCR2) becomes larger than the threshold value THtbd, and a discontinuity of timebase is erroneously detected.

Explanation will now be given of the operations of each part when the PCR packet generating unit 119 generates a TS packet including PCR′1 and PCR′2 in the receiving error section in FIG. 4 as shown in FIG. 5. First, the syntax analyzing unit 105 analyzes the PCR1, and sets the timer 118. When the current time (prevPCRtime) is returned from the timer 118, the syntax analyzing unit 105 transfers the prevPCRtime, the PCR1 (curPCR) and PID indicating TS packet including PCR to the PCR packet generating unit 119. The PCR1 is provided to the discontinuity detecting unit 116 by the PID filter 106, but as the PCR1 is a first PCR as described before, the discontinuity detecting unit 116 records the PCR1 as prevPCR without detecting a discontinuity of timebase. Then, the syntax analyzing unit 105 analyzes the PCR2, and sets the timer 118. When the current time (prevPCRtime) is returned from the timer 118, the syntax analyzing unit 105 transfers the prevPCRtime, the PCR2 (curPCR) and PID indicating TS packet including PCR to the PCR packet generating unit 119. The PCR2 is provided to the discontinuity detecting unit 116 by the PID filter 106, and the previously described timebase discontinuity detecting operation is performed. The discontinuity detecting unit 116 calculates ΔPCR by regarding the PCR2 as curPCR. As ΔPCR (=PCR2−PCR1) is lower than the threshold value THtbd, a discontinuity of timebase is not detected, and the discontinuity detecting unit 116 records the PCR2 as prevPCR.

As the receiving error section is longer than the threshold value THtbd as described above, the threshold value THtime (<THtbd) elapses from prevPCRtime (a time to receive a TS packet including PCR2), before a TS packet including PCR is newly received. Then, the timer 118 transmits the current time (curPCRtime) to the packet receiving unit 104. Obtaining the curPCRtime from the timer 118, the packet receiving unit 104 actuates the PCR packet generating unit 119, and transmits the time curPCRtime to the PCR packet generating unit 119. The PCR packet generating unit 119 calculates PCR′1 as a pseudo PCR by using the transmitted curPCRtime, and prevPCR (PCR2) and prevPCRtime (a time to receive a TS packet including PCR2) already transferred from the syntax analyzing unit 105. More specifically, the PCR packet generating unit 119 calculates PCR′1 by curPCR=prevPCR+(curPCRtime−prevPCRtime), by assuming a pseudo PCR to be curPCR. As curPCRtime−prevPCRtime becomes equal to the threshold value THtime if a processing delay is not considered, curPCR may be calculated more simply by adding the threshold THtime to prevPCR. The PCR packet generating unit 119 generates a TS packet by adding PID indicating the PCR previously obtained from the syntax analyzing unit 105 to the calculated pseudo PCR′1, and transfers the generated TS packet to the packet receiving unit 104. The packet receiving unit 104 transfers the TS packet to the syntax analyzing unit 105, just like a TS packet from an ordinary broadcast signal.

Then, the syntax analyzing unit 105 analyzes the PCR′1, and sets the timer 118. When the current time (prevPCRtime) is transmitted from the timer 118, the syntax analyzing unit 105 transfers the prevPCRtime, the PCR′1 (curPCR) and PID indicating TS packet including PCR to the PCR packet generating unit 119. The PCR′1 is provided to the discontinuity detecting unit 116 by the PID filter 106, and the previously described timebase discontinuity detecting operation is performed. The discontinuity detecting unit 116 calculates ΔPCR by regarding the PCR′1 as curPCR. As ΔPCR (=PCR′1−PCR≈Threshold value THtime) is lower than the threshold value THtbd, a discontinuity of timebase is not detected, and the discontinuity detecting unit 116 records the PCR′1 as a prevPCR.

Then, the threshold value THtime elapses from prevPCRtime (a time to receive a TS packet including PCR′1), before a TS packet including PCR is received, as described hereinbefore. Then, the timer 118 transmits the current time (curPCRtime) to the packet receiving unit 104. Obtaining the time curPCRtime from the timer 118, the packet receiving unit 104 actuates the PCR packer generating unit 119, and transmits the time curPCRtime.

The PCR packet generating unit 119 calculates PCR′2 as a pseudo PCR, by using the reported curPCRtime, prevPCR (PCR′1) and prevPCRtime (a time to receive a TS packet including PCR′1) already transferred from the syntax analyzing unit 105, just like calculating the PCR′1. The PCR packet generating unit 119 generates a TS packet by adding PID indicating the TS packet including PCR obtained from the syntax analyzing unit 105 to the calculated PCR′2, and sends the generated TS packet to the packet receiving unit 104. The packet receiving unit 104 transfers the TS packet to the syntax analyzing unit 105, just like transferring a TS packet from an ordinary broadcast signal.

Then, the syntax analyzing unit 105 analyzes the PCR′2, and sets the timer 118. When the current time (prevPCRtime) is transmitted from the timer 118, the syntax analyzing unit 105 transfers the prevPCRtime, the PCR′2 (curPCR) and PID indicating TS packet including PCR to the PCR packet generating unit 119. The PCR′2 is provided to the discontinuity detecting unit 116 by the PID filter 106, and the previously described timebase discontinuity detecting operation is performed. The discontinuity detecting unit 116 calculates ΔPCR by regarding the PCR′2 as curPCR. As ΔPCR (=PCR′2−PCR′1≈Threshold value THtime) is lower than the threshold value THtbd, a discontinuity of timebase is not detected, and the discontinuity detecting unit 116 records the PCR′2 as a prevPCR.

Then, having been over the error section, a TS packet including PCR3 is normally received. The syntax analyzing unit 105 analyzes the PCR3, and set the timer 118. When the current time (prevPCRtime) is transmitted from the timer 118, the syntax analyzing unit 105 transfers the prevPCRtime, the PCR3 (curPCR) and PID indicating TS packet including PCR to the PCR packet generating unit 119. The PCR3 is provided to the discontinuity detecting unit 116 by the PID filter 106, and the previously described timebase discontinuity detecting operation is performed. The discontinuity detecting unit 116 calculates ΔPCR by regarding the PCR3 as curPCR. As ΔPCR (=PCR3−PCR′2<Threshold value THtime) is lower than the threshold value THtbd, a discontinuity of timebase is not detected, and the discontinuity detecting unit 116 records the PCR3 as a prevPCR.

As explained above, when a TS packet including PCR is not received for a certain time (threshold value THtime), the PCR packet generating unit 119 generates a TS packet including a calculated pseudo PCR.

### Therefore,

ΔPCR does not increase over a certain value (≈Threshold value THtime<Threshold value THtbd), and erroneous detection of a discontinuity of timebase can be prevented.

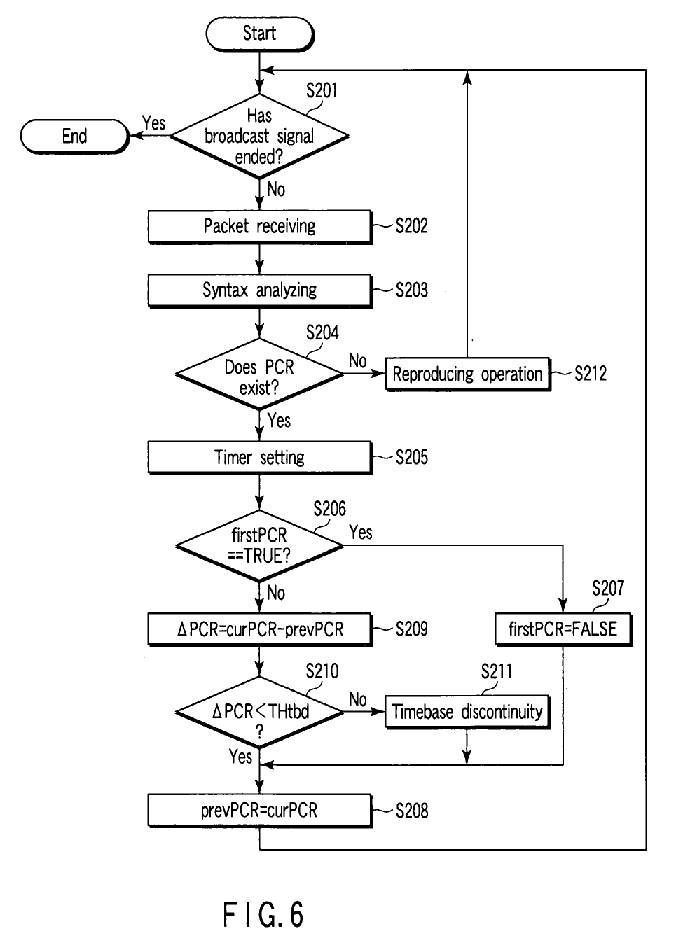

Next, explanation will be given of the operations of the stream reproducing apparatus shown in FIG. 1 with reference to the flowchart of FIG. 6.

First, the packet receiving unit 104 confirms whether a broadcast signal has ended (step S201). When a broadcast signal has ended, a stream reproducing operation is finished. If a broadcast signal has not ended, the packet receiving unit 104 receives a TS packet from the demodulating unit 103 or PCR packet generating unit 119, and transfers the received TS packet to the syntax analyzing unit 105 (step S202). The syntax analyzing unit 105 analyzes each syntax in the TS packet received in step S202 (step S203).

Then, the syntax analyzing unit 105 refers to a PCR flag in an adaptation field, for example, and determines whether PCR is included in a TS packet to be processed (step S204). When PCR is included in a TS packet to be processed, the syntax analyzing unit 105 sets the timer 118 to report a time after the threshold value THtime elapses to the packet receiving unit 104, and receives the current time (prevPCRtime) (step S205). Receiving the prevPCRtime from the timer 118, the syntax analyzing unit 105 reports the PCR included in the processing TS packet and PID indicating a TS packet including PCR to the packet generating unit 119. The processing TS packet is transferred from the syntax analyzing unit 105 to the PID filter 106, and the PCR in the TS packet is extracted and provided to the discontinuity detecting unit 116.

Then, the discontinuity detecting unit 116 determines whether the firstPCR flag is true or false (step S206). When the flag first PCR is true, the discontinuity detecting unit 116 sets the firstPCR flag to false, and goes to step S208 (step S207).

In step S208, the discontinuity detecting unit 116 holds the processing PCR as prevPCR, and returns to step S201 to process the next TS packet.

Conversely, if PCR is not included in the processing TS packet (step S204), the TS packet is provided to each part from the PID filter 106 according to PID. Namely, the TS packet is provided to the ES extracting unit 107 when the PID indicates video, and provided to the ES extracting unit 111 when the PID indicates audio, and a predetermined reproducing operation is performed (step S212). After the end of step S212, the discontinuity detecting unit 116 returns to step S201 to process the next TS packet.

When the firstPCR flag is false (step S206), the discontinuity detecting unit 116 calculates ΔPCR by subtracting prevPCR from the processing PCR (curPCR), to detect a discontinuity of timebase (step S209). Then, the discontinuity detecting unit 116 determines whether the ΔPCR calculated in step S209 is less than the threshold value THtbd. If the ΔPCR is less than the threshold value THtbd, the discontinuity detecting unit 116 goes to step S208 (step S210). If the ΔPCR is not less than the threshold value THtbd, the discontinuity detecting unit 116 detects a discontinuity of timebase, performs a predetermined resetting operation, and goes to step S208 (step S211).

Next, explanation will be given of the operations of the PCR packet generating unit 119 shown in FIG. 1 with reference to the flowchart of FIG. 7.

First, the packet receiving unit 104 having been informed of the current time by the timer 118 actuates the PCR packet generating unit 119. The PCR packet generating unit 119 sets the current time transmitted from the packet receiving unit 104 at the startup as a time curPCRtime (step S301).

Then, the PCR packet generating unit 119 calculates curPCR as pseudo PCR (step S302). The PCR packet generating unit 119 calculates curPCR by using the prevPCR and prevPCRtime already transferred from the syntax analyzing unit 105, and the time curPCRtime set in step S301, as described hereinbefore. More specifically, the PCR packet generating unit 119 calculates curPCR by adding the difference between the time curPCRtime and time prevPCRtime to the prevPCR, as described hereinbefore.

Then, the PCR packet generating unit 119 generates a TS packet having the curPCR calculated in step S302 as PCR (step S303). More specifically, the PCR packet generating unit 119 generates a TS packet having the PID indicating the TS packet including the PCR already transmitted from the syntax analyzing unit 105, and having the curPCR calculated in step S302 as PCR. Then, the PCR packet generating unit 119 transfers the TS packet generated in step S303 to the packet receiving unit 104 (step S304). The TS packet transferred in step S304 is received by the packet receiving unit 104 in the above-mentioned step S202, and the operations on after step S203 are performed.

As explained hereinbefore, in this embodiment, when a TS packet including PCR is not received for a certain time due to a receiving error, a TS packet including a calculated pseudo PCR is generated. Therefore, according to this embodiment, unless a timebase is changed, the difference between continuous PCRs is not increased exceeding the above-mentioned certain time, and an erroneous detection of a discontinuity of timebase due to a receiving error can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A contents reproducing apparatus comprising:
a receiving unit configured to receive a plurality of packets that convey an elementary stream containing encoded video or audio data and time information;
a detecting unit configured to detect a discontinuity of timebase if the difference between first time information contained in a first packet and second time information contained in a second packet received before the first packet is larger than a first threshold value;
a timer configured to output the current time after a second threshold value smaller than the first threshold value elapses from a time to receive the first packet;
a generating unit configured to generate a third packet including a third time information calculated based on the first time information and transfer the third packet to the receiving unit, when receiving the current time from the timer; and
a decoder configured to decode the video or audio data contained in the elementary stream.

2. The apparatus according to claim 1, wherein the generating unit is configured to generate the third packet including the third time information obtained by adding the second threshold value to the first time information and transfer the third packet to the receiving unit, when receiving the current time from the timer.

3. The apparatus according to claim 1, wherein the generating unit is configured to generate the third packet including the third time information obtained by adding an increment from the receiving time of the first packet to the current time to the first time information and transfer the third packet to the receiving unit, when receiving the current time from the timer.

4. The apparatus according to claim 1, wherein the second threshold value is a maximum cycle that the first and second packets are transmitted.

5. The apparatus according to claim 1, wherein the detecting unit omits detection if the second time information does not exist.

6. A contents reproducing apparatus comprising:
a receiving unit configured to receive a plurality of packets that convey encoded video or audio data and reference clock information;
a detecting unit configured to detects a discontinuity of timebase if the difference between a first reference clock information contained in a first packet and second reference clock information in a second packet received before the first packet is larger than a first threshold value;
a timer configured to output the current time after a second threshold value smaller than the first threshold value elapses from a time to receive the first packet;
a generating unit configured to generate a third packet including a third reference clock information calculated based on the first reference clock information and transfer the third packet to the receiving unit, when receiving the current time from the timer; and
a decoder configured to decode the video or audio data contained in the stream.

7. The apparatus according to claim 6, wherein the generating unit is configured to generate the third packet including the third time information obtained by adding the second threshold value to the first time information and transfer the third packet to the receiving unit, when receiving the current time from the timer.

8. The apparatus according to claim 6, wherein the generating unit is configured to generate the third packet including the third reference clock information obtained by adding an increment from the receiving time of the first packet to the current time to the first reference clock information and transfer the third packet to the receiving unit, when receiving the current time from the timer.

9. The apparatus according to claim 6, wherein the second threshold value is a maximum cycle that the first and second packets are transmitted.

10. The apparatus according to claim 6, wherein the detecting unit omits detection if the second reference clock information does not exist.

11. A contents reproducing apparatus comprising:
a receiving unit configured to receive a plurality of TS packets, each TS packet contains a segment divided from an elementary stream obtained by coding video data, and clock reference information used for adjusting a system clock;
a detector configured to detect a discontinuity if the difference between first clock reference information contained in a first TS packet and second clock reference information contained in a second TS packet received prior to the first TS packet is larger than a first threshold value;
a timer configured to output a time information after a second threshold value smaller than the first threshold value elapses from a time to receive the first packet;
a generator configured to generate a third TS packet containing a third clock reference information calculated based on the first clock reference information and transfer the third TS packet to the receiving unit, when receiving the time information from the timer; and
a decoder configure to decode the video data contained in the elementary stream.

12. The apparatus according to claim 11, wherein the generator is configured to generate the third TS packet including the third clock reference information obtained by adding the second threshold value to the first clock reference information and transfer the third TS packet to the receiving unit, when receiving the time information from the timer.

13. The apparatus according to claim 11, wherein the generator is configured to generate the third TS packet including the third clock reference information obtained by adding an increment from the receiving time of the first TS packet to the time information to the first clock reference information and transfer the third TS packet to the receiving unit, when receiving the time information from the timer.

14. The apparatus according to claim 11, wherein the second threshold value is a maximum cycle that the first and second TS packets are transmitted.

15. The apparatus according to claim 11, wherein the detector omits detection if the second clock reference information does not exist.
